(19) United States
(12) Patent Application Publication
(10) Pub. No.: US 2025/0126155 A1
(43) Pub. Date: Apr. 17, 2025

(54) ORGANIZATION-SPECIFIC CYBERSECURITY DIALOGUE SYSTEM WITH LARGE LANGUAGE MODELS

(71) Applicant: Palo Alto Networks, Inc., Santa Clara, CA (US)

(72) Inventors: Praveen Tiwari, Milpitas, CA (US); Gaurav Sharma, Mountain View, CA (US); Sayali Pradip Kamat, San Jose, CA (US); Sakshi Mahendru, Santa Clara, CA (US); Tejul Mayank Pandit, Sunnyvale, CA (US); Charanraj Thimmisetty, Dublin, CA (US); Wen Jiang, Sunnyvale, CA (US)

(21) Appl. No.: 18/487,256

(22) Filed: Oct. 16, 2023

(51) Int. Cl. H04L 9/40; G06F 40/20

(52) U.S. Cl. CPC H04L 63/205; G06F 40/20

(57) ABSTRACT

An organization-specific cybersecurity dialogue system (“system”) intelligently generates responses to user utterances for cybersecurity by employing documentation and playbook agents for an associated cybersecurity organization. The system extracts an intent and an intent category from a user utterance, extracts relevant entities from the intent and uses them to determine relevant user telemetry data, and matches the intent, intent category, and user telemetry data to documents of the cybersecurity organization. The system then determines whether to generate a response based on matching document, matching playbook agents, or to prompt a user to create a ticket according to logic applied to the intent, intent category, user telemetry data, and matching documents and generates a corresponding response with large language models.

### BACKGROUND

The disclosure generally relates to computing arrangements based on computational models (e.g., CPC G06N) and electrical digital data processing related to handling natural language data (e.g., CPC G06F 40/00).

Dialogue systems are sometimes referred to as chatbots, conversation agents, or digital assistants. While the different terms may correspond to different types of dialogues systems, the commonality is that they provide a conversational user interface. Some functionality of dialogue systems includes intent classification and entity extraction. Dialogue systems have been designed as rule-based dialogue systems and many commercially deployed dialogue systems are rule-based. However, statistical data-driven dialogue systems that use machine learning have become a more popular approach. A statistical data-driven dialogue system has components that can include a natural language understanding (NLU) component, a dialogue manager, and a natural language generator. Some statistical data-driven dialogue systems use language models or large language models. A language model is a probability distribution over sequences of words or tokens. A large language model (LLM) is “large” because the training parameters are typically in the billions. Neural language model refers to a language model that uses a neural network(s), which includes Transformer-based LLMs.

The “Transformer” architecture was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. Architecture of a Transformer model typically is a neural network with transformer blocks/layers, which include self-attention layers, feed-forward layers, and normalization layers. The Transformer model learns context and meaning by tracking relationships in sequential data. The Transformer architecture has been referred to as a “foundational model.” The Center for Research on Foundation Models at the Stanford Institute for Human-Centered Artificial Intelligence used this term in an article “On the Opportunities and Risks of Foundation Models” to describe a model trained on broad data at scale that is adaptable to a wide range of downstream tasks.

### BRIEF DESCRIPTION OF THE DRAWINGS

Embodiments of the disclosure may be better understood by referencing the accompanying drawings.

FIG. 1 is a schematic diagram of an example dialogue system for generating high quality responses to cybersecurity related user utterances that incorporate knowledge specific to a cybersecurity organization.

FIG. 2 is a flowchart of example operations for generating a response to a user utterance a cybersecurity issue.

FIG. 3 is a flowchart of example operations for ranking matching documents and generating a response to an utterance based on the ranked documents, user intent, intent category, and telemetry data.

FIG. 4 depicts an example computer system with an organization-specific cybersecurity dialogue system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Users that are customers of security appliances/services deployed by a cybersecurity organization can experience support issues related to general cybersecurity, troubleshooting, security appliance/service configuration, etc. Responses to user utterances related to these issues often rely on data specific to the organization, for instance, firewall configuration steps specific to firewalls manufactured and/or implemented by the cybersecurity organization. Prompt generation for large language models (“LLMs”) (or, more generally, any generative language model) configured to respond to user utterances with one-or few-shot prompting should incorporate organization-specific data that is relevant to the user utterance. Identification and retrieval of organization-specific data relevant to the user utterance relies on determining intent of the user utterance and accurately searching databases of organizational knowledge for data relevant to the intent and context. Moreover, responses often rely on telemetry data for the user that indicates corresponding security appliances/services, previous user utterances and responses, etc.

A user support pipeline disclosed herein generates high quality responses to cybersecurity related user utterances that incorporate organization-specific data. An intent classification model determines a category of intent for a user utterance and additionally generates a normalized intent of the user utterance. An entity and metadata extractor receives the normalized intent and intent category and searches a user telemetry database for telemetry data relevant to the user utterance. A knowledge retrieval engine receives the normalized intent, intent category, and the user telemetry data and searches an organizational knowledge database for organizational documents relevant to the user utterance. The knowledge retrieval engine searches the organizational knowledge database based on both semantic similarity and lexical similarity. A response ranker then fuses similarity rankings of the documents by combining semantic rank and lexical rank for each document. A response type evaluator then determines whether to send the user knowledge articles, a prompt for ticket creation, or a response generated by playbook agents according to logic for whether there are matching documents in the organizational knowledge database and/or playbook agents matching the normalized intent, intent category, and user telemetry data. For the responses indicating or including high ranked documents, a response generator generates abstractive summaries for the high ranked documents and uses the abstractive summaries and normalized intent to generate one or more prompts to a LLM that generates the response to the user. The resulting responses, whether generated by a playbook or from high ranked documents, facilitate triage of user utterances and improve quality of user experience.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

A “security appliance” as used presently refers to any hardware or software instance for cybersecurity.

### Example Illustrations

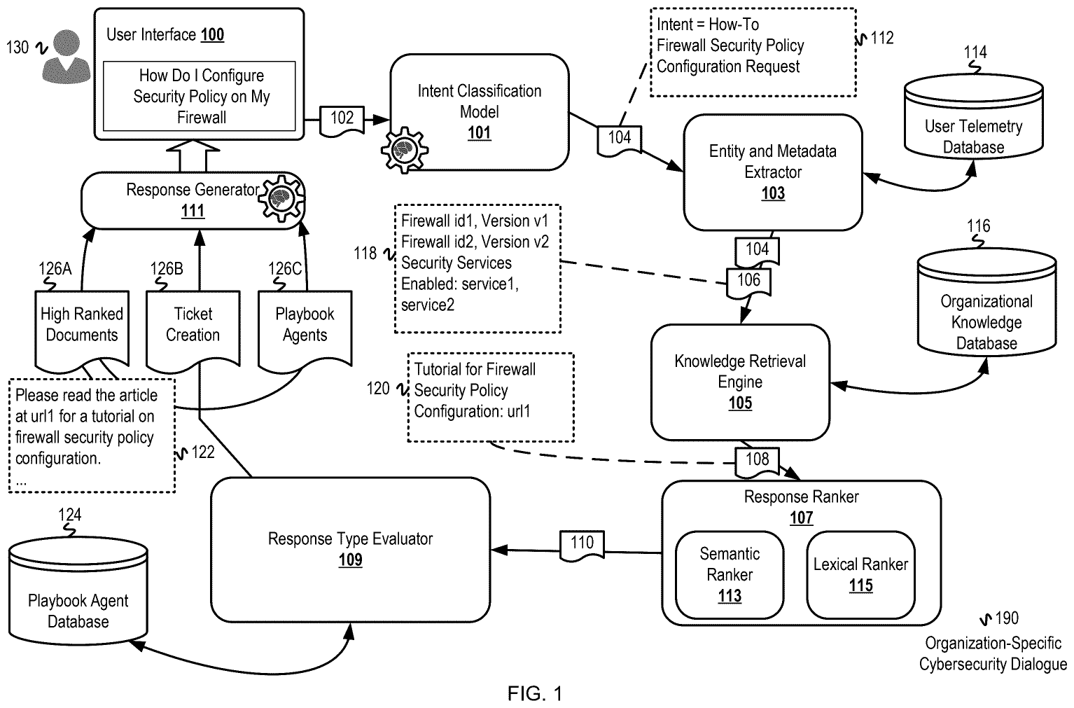

FIG. 1 is a schematic diagram of an example dialogue system for generating high quality responses to cybersecurity related user utterances that incorporate knowledge specific to a cybersecurity organization. An organization-specific cybersecurity dialogue system (dialogue system) 190 comprises an intent classification model 101 to determine intent categories of user utterances, an entity and metadata extractor 103 to retrieve telemetry data of users relevant to the user utterances, a knowledge retrieval engine 105 to retrieve organization-specific knowledge related to the user utterances, a response ranker 107 to rank relevance of documents returned by the knowledge retrieval engine 105 to the user utterances, a response type evaluator 109 to determine types of responses to each user utterance based at least partially on documents ranked by the response ranker 107, and a response generator 111 to generate a response to each user utterance.

A user interface 100 interfaces with a user 130 of one or more cybersecurity security appliances/services manufactured or implemented by a cybersecurity organization (not depicted). The user interface 100 communicates an utterance 102 by the user 130 to the intent classification model 101. An example utterance by the user 130 at the user interface 100 comprises the utterance “how do I configure security policy on my firewall”. The intent classification model 101 generates an intent category and a normalized intent from the utterance 102. For instance, the intent classification model 101 can comprise a LLM prompted to rephrase the utterance 102 to extract most relevant natural language context (i.e., a succinct description or summary of the utterance without extraneous and irrelevant language) and an intent category. For instance, the prompt(s) can describe the intent categories alongside examples to the LLM and ask the LLM to predict an intent category for the utterance 102 and to generate a concise summary or rephrasing of the utterance 102. The prompt(s) were previously engineered and validated for quality responses by the dialogue system 190, for instance by generating prompts according to an engineered template for example utterances with known intent categories and concise summaries. Alternatively, the intent classification can comprise an intent classifier trained on utterances labelled by intent category (e.g., general cybersecurity knowledge, troubleshooting, how-to, etc.) and a separate language model that generates the normalized intent, e.g., an abstractive summarization language model. Example intent 112 comprises an intent category of “how-to” and a normalized intent “firewall security policy configuration request”. In the depicted example, the normalized intent removes extraneous phrasing such as “how do I” and “on my” to extract language most relevant to the intent of the user 130, i.e., to learn how to configure a security policy on their firewall(s). The intent classification model 101 communicates the intent 104 comprising the intent category and the normalized intent generated from the utterance 102 to the entity and metadata extractor 103.

The entity and metadata extractor 103 identifies relevant entities in the intent 104 (e.g., “firewall”, “service1”, etc.) and communicates queries to a user telemetry database 114 with indications of the user 130 and the relevant entities. The user telemetry database 114 responds with telemetry data relevant to the user 130. For instance, example user telemetry data 118 comprises firewalls id1, id2 with versions v1, v2, respectively, deployed for the user 130 as well as security services service1, service2 enabled by the user 130. The entity and metadata extractor 103 then matches the relevant entities from the intent 104 to telemetry data returned by the user telemetry database 114. For instance, the entity and metadata extractor 103 can match words in the intent 104 with keywords for the cybersecurity organization (e.g., “firewall”) and can include telemetry data relevant to those keywords (e.g., firewall identifier, version number, etc.) in user telemetry data 106. In some instances, the entity and metadata extractor 103 can determine that there is no telemetry data in the user telemetry database 114 relevant to the utterance 102, for instance when the utterance 102 is a general cybersecurity question. If the entity and metadata extractor 103 is unable to determine relevant entities to the intent 104, e.g., when the user 130 or associated tenant has multiple firewalls and/or services, the entity and metadata extractor 103 can generate a response to the user 130 to specify which security appliance(s) and/or service(s) relate to the utterance 102. Based on a response utterance by the user 130 clarifying the security appliance(s) and/or service(s), the entity and metadata extractor 103 can filter telemetry data for other security appliance(s) and/or service(s) not specified by the user 130. The entity and metadata extractor 103 communicates user telemetry data 106 as well as the intent 104 to the knowledge retrieval engine 105. Telemetry data such as the user telemetry data 106 is referred to variously as “metadata” throughout.

The knowledge retrieval engine 105 communicates queries to an organizational knowledge database 116 that indicate the intent 104 and the user telemetry data 106. The organizational knowledge database 116 comprises documents for the cybersecurity organization such as webpages, datasheets, etc. indexed with sparse word-based embeddings and dense context-based embeddings. For instance, the sparse embeddings can comprise one-hot encodings of tokens in each document and the dense embeddings can comprise doc2vec embeddings of each document. The organizational knowledge database 116 (or the knowledge retrieval engine 105) generates sparse embeddings and dense embeddings for the queries and searches for sparse embedding matches and dense embedding matches. Sparse embedding matches correspond to lexical similarity and can be quantified using, for instance, the Okapi BM25 ranking function. Dense embeddings correspond to semantic similarity and can be quantified, for instance, by Euclidean distance between embeddings of the queries and embeddings of documents in the organizational knowledge database 108. An example document 120 relevant to the utterance 102 comprises a description that indicates that a tutorial for firewall security policy configuration can be accessed at Uniform Resource Locator (URL) url1. Alternatively, the example document 120 could comprise the firewall security policy configuration tutorial itself and could be matched to the firewall version/type. The knowledge retrieval engine 105 communicates documents and lexical and semantic similarity metrics, later referred to as “relevance scores”, to the response ranker 107.

The response ranker 107 comprises a semantic ranker 113 and a lexical ranker 115. In some embodiments, documents can be ranked by the organizational knowledge database 116 according to lexical similarity and semantic similarity in responses to queries by the knowledge retrieval engine 105. The response ranker 107 then fuses the semantic rankings and lexical rankings to generate an overall ranking 110 that the response ranker 107 communicates to a response type evaluator 109. The fused ranking is generated based on a relevance scoring system that weighs semantic rank and lexical rank, wherein the overall ranking 110 is computed as highest to lowest scoring documents. For instance, documents can be ranked by an averaged semantic and lexical score. The combined score can vary by weighting (e.g., to favor higher-ranked documents) and can weigh lexical similarity more or less heavily than semantic similarity. Parameters for computing the score can be tuned based on observed relevance of high ranked documents to corresponding utterances. In embodiments where the organizational knowledge database 116 returns no documents or when the overall score is below a threshold score for relevance to the utterance 102, the overall ranking 110 can comprise indications of no documents. The response ranker 107 communicates the overall ranking 110 to the response type evaluator 109.

A response type evaluator 109 applies logic to determine whether to generate a response based on matching documents or based on playbook agents or a response that prompts the user 130 to create a ticket. If the overall ranking 110 indicates at least one document and the user telemetry data 106 does not indicate one or more security appliances associated with the user 130 or with a tenant for the user 130, the response type evaluator 109 communicates the high ranked (e.g., top-3) documents 126A to the response generator 111. The response generator 111 generates abstractive summaries of each of the high ranked documents 126A and generates one or more prompts to an LLM to generate a response to the user 130 via the user interface 100. For instance, the generated prompt can prompt the LLM to generate a response that includes the abstractive summaries, hyperlinks to where the high ranked documents 126A can be accessed, as well as indications of tone and verbosity for the response. The one or more generated prompts were previously engineered by the dialogue system 190 to ensure high quality responses by the LLM. An example response 122 comprises the following: Please read the article at url1 for a tutorial on firewall security policy configuration. The example response 122 can further comprise an abstractive summarization of the content of the article at url1.

If the response type evaluator 109 determines that the overall ranking 110 indicates no documents but the user telemetry data 106 indicates one or more security appliances for the user 130 or a tenant, the response type evaluator 109 queries a playbook agent database 124 with the intent 104 and the user telemetry data 106 to identify any matching playbook agents. Alternatively, if the overall ranking 110 indicates documents but the user telemetry data 106 also indicates one or more security appliances, the response type evaluator 109 also queries the playbook agent database 124 to identify matching playbook agents. For instance, for identifying matching playbook agents, each playbook agent can have a set of criteria that, when satisfied, trigger the playbook agent. For instance, the playbook can specify that certain security rules are present or not present in a security policy at a firewall of the user 130 (e.g., as indicated in the user telemetry data 106). Based on matching one or more playbook agents 126C in the playbook agent database 124, the response type evaluator 109 executes the playbook agents 126C to generate a response to the user 130. The playbook agents 126C can specify input data such as firewall identifiers, firewall versions, enabled services, security policy configurations, etc. for the response generator 111. If there are no matching playbook agents in the playbook agent database 124, the response type evaluator generates a prompt 126B for ticket creation by the user 130.

If the response type evaluator 109 determines that the overall ranking 110 indicates no documents and there are no matching playbook agents in the playbook agent database 124, the response type evaluator 109 (or the response generator 111) generates the prompt 126B for ticket creation by the user 130. The prompt can indicate to the user 130 to specify associated firewalls, firewall versions, services, etc. related to the utterance 102 to facilitate triage of tickets and can indicate categories of intent for the user 130 to specify. The logic employed by the response type evaluator 109 is example logic for determining a response type based on matching documents and matching playbook agents to the utterance 102. Different implementations of the system 190 can employ different logic. For instance, the system 190 can analyze the intent 104 directly to determine whether to make a response via documents, playbook agents, or that prompts ticket creation.

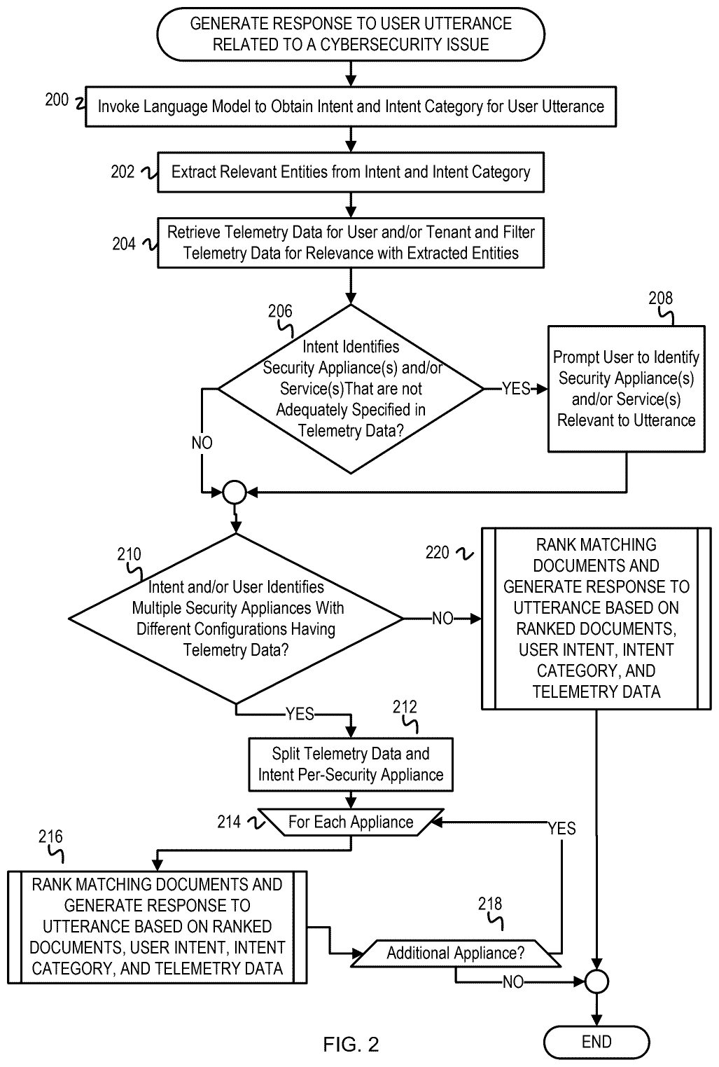

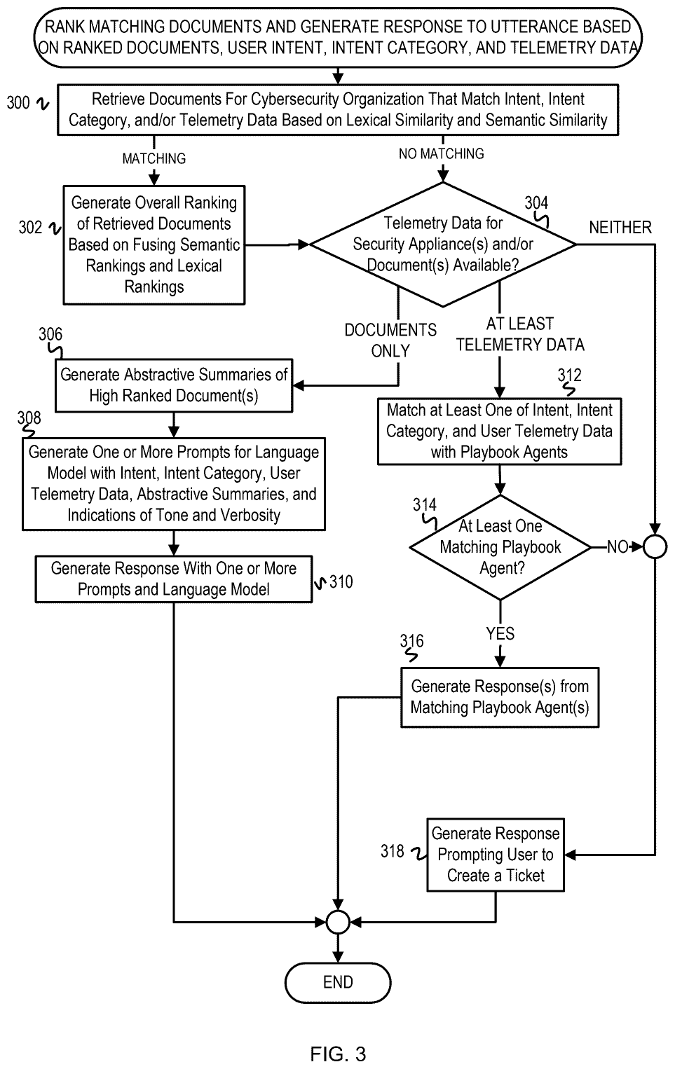

FIGS. 2-3 are flowcharts of examples operations for generating cybersecurity domain-based responses to utterances. The example operations are described with reference to an organization-specific cybersecurity dialogue system (“dialogue system”) for consistency with the earlier figure and/or ease of understanding. The dialogue system comprises sub-components in a pipeline described in the foregoing that can perform any of the described operations, and the sub-components are collectively grouped into the dialogue system for simplicity. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.'

FIG. 2 is a flowchart of example operations for generating a response to a user utterance related to a cybersecurity issue. The utterance can fall into various intent categories such as general cybersecurity (i.e., not necessarily specific to the cybersecurity organization), troubleshooting, how-to, etc. The user utterance comprises an utterance by a user or tenant entity that owns or subscribes to various security appliance(s) and/or service(s) provided by the cybersecurity organization that may or may not be indicated in the utterance.

At block 200, a dialogue system invokes a language model to obtain an intent category and an intent for an utterance. For instance, the language model can comprise an LLM pretrained on general natural language context and the dialogue system can invoke the LLM by generating one or more prompts to the LLM to obtain the intent and intent category. The intent comprises a rephrasing of the utterance to remove extraneous language and isolate what the utterance is requesting. To exemplify, the dialogue system can generate a prompt describing each of the intent categories to the LLM along with examples thereof and can generate a subsequent prompt that queries the LLM to classify the utterance into one of the described intent categories. Additional prompts generated by the dialogue system can query the LLM to rephrase the utterance to improve interpretability and promote succinct language. In some instances, the LLM can, in response to the prompts, predict multiple intent categories for the utterance. Other language models such as abstractive summarization generation models can be used to generate the intent and predicting the intent category can alternatively be performed with any classification model trained on utterances labelled by intent category.

At block 202, the dialogue system extracts relevant entities from the intent and the intent category. A relevant entity from the intent category can comprise the intent category itself, while relevant entities from the intent can comprise keyword matches against a database of keywords for entities relevant to the cybersecurity organization (e.g., “firewall”, “service”, “version”, “security policy”, “security rule”, “configuration”, etc.). In other embodiments, the dialogue system can implement an entity recognition model to recognize entities relevant to the cybersecurity organization, wherein the entity recognition model is pretrained on intents labelled with corresponding entities/entity types therein.

At block 204, the dialogue system retrieves telemetry data for the user and/or a tenant associated with the user and filters the telemetry data for relevance with the extracted entities. The dialogue system queries a database with indications of the user and/or tenant depending on whether stored telemetry data is indexed per-user or per-tenant. In some implementations, the cybersecurity organization may not have knowledge of which products/services/security appliances are associated with which users and the returned telemetry data may be across a tenant including the user. The dialogue system then filters the returned telemetry data based on the extracted entities by identifying subsets of the telemetry data that include or indicate one or more of the extracted entities. For instance, the dialogue system can perform a partial or exact match for the extracted entities in the telemetry data. The partial or exact match can indicate subsets of the telemetry data comprising partial or exact matched entities based on surrounding punctuation and whitespaces and/or according to data formats for storing the telemetry data by the cybersecurity organization. The dialogue system can then filter telemetry data not in the identified subsets.

At block 206, the dialogue system determines whether the intent identifies security appliance(s) and/or service(s) that are not adequately specified in the telemetry data. For instance, based on determining that the intent identifies a firewall and version number, the dialogue system can access telemetry data of security appliances/services assigned to a tenant for the user and, after identifying multiple of the firewalls with the version specified by the intent, can determine that the security appliance is not adequately specified in the telemetry data. Conversely, if the telemetry data specifies a unique firewall with the specified version, the dialogue system can determine that the telemetry data adequately specifies the security appliance indicated in the intent. In embodiments where the intent does not specify or relate to a security appliance or service (e.g., when the intent category is general cybersecurity), the dialogue system can determine that the telemetry data adequately specifies security appliance(s) and/or service(s) identified by the intent because the intent has not identified any security appliance(s) and/or service(s). In other embodiments, the dialogue system can determine that the intent relates to a security appliance(s) and/or service(s) not explicitly identified by the intent (e.g., when the intent asks for security policy configuration troubleshooting when the troubleshooting depends on a version of a firewall for the user) and can determine whether the telemetry data adequately specifies the implicitly identified security appliance(s) and/or service(s). If the dialogue system determines that security appliance(s) and/or service(s) identified by the dialogue system are not adequately identified by the telemetry data, operational flow proceeds to block 208. Otherwise, operational flow skips to block 210.

At block 210, the dialogue system determines whether the intent and/or user identifies multiple security appliances with different configurations having telemetry data. Some security appliances may be configured such that telemetry data is not collected despite being identified by the intent and/or user. Responses can differ for user utterances directed at security appliances with different configurations, and thus each security appliance with a different configuration has a distinct response generated by the dialogue system. For instance, a firewall deployed in a public-facing network that communicates with the Internet may have different steps for upgrading its version than a firewall deployed in a private network due to increased risks of being exposed to network traffic from the Internet, despite both firewalls having the same model and version. If the dialogue system determines that the intent and/or user identifies multiple security appliances with different configurations having telemetry data, operational flow proceeds to block 212. Otherwise, operational flow proceeds to block 220.

At block 212, the dialogue system splits the telemetry data and intent per-security appliance. For instance, the dialogue system can replace the intent with a separate intent for each security appliance by replacing a description of the security appliance (e.g., “firewall”) in the intent with an identifier of the security appliance as well as the corresponding product/model and version (e.g., “next generation firewall id1 version 2.0”).

At block 214, the dialogue system begins iterating through security appliances in the original intent. At block 216, the dialogue system ranks matching documents and generates a response to the utterance based on the ranked documents, user intent, intent category, and telemetry data. The user intent, intent category, and telemetry data are those for the security appliance at the current iteration. The dialogue system additionally communicates the generated response to the user (e.g., via a user interface). The dialogue system can communicate responses as they are generated for each security appliance or can communicate responses across all security appliances after they are generated. The operations at block 216 are described in greater detail in reference to FIG. 3. At block 218, the dialogue system continues iterating through security appliances in the original intent. If there is an additional security appliance, operational flow returns to block 214. Otherwise, the operational flow in FIG. 2 terminates.

At block 220, the dialogue system ranks matching documents and generates a response to the utterance based on the ranked documents, user intent, intent category, and telemetry data. The dialogue system subsequently communicates the generated response to the user, for instance via a user interface. The operations at block 220 are described in greater detail in reference to FIG. 3.

FIG. 3 is a flowchart of example operations for ranking matching documents and generating a response to an utterance based on the ranked documents, user intent, intent category, and telemetry data. At block 300, a dialogue system retrieves documents for a cybersecurity organization that match intent, intent category, and/or telemetry data for a user utterance corresponding to the intent and the intent category based on lexical similarity and semantic similarity. The documents can comprise documents from webpages or documentation of the organization, e.g., documentation of application programming interfaces (APIs) for firewalls or services, general knowledge articles on various cybersecurity topics, etc. The documents can further comprise general knowledge articles originating from outside the cybersecurity organization, e.g., a request for comments (RFC), Internet Assigned Numbers Authority (IANA) documents, third-party documentation of services (e.g., Software-as-a-Service applications), etc.

The dialogue system can maintain databases of embeddings of the documents—a first database with dense (semantic) embeddings and a second database with sparse (lexical) embeddings. The sparse embeddings can comprise one-hot encodings of tokens in each document and the dense embeddings can comprise doc2vec embeddings of each document. The dialogue system generates the sparse and dense embeddings for the intent, intent category, and telemetry data. The dialogue system then searches the first database and second database for dense and sparse embeddings, respectively, that are sufficiently close to the sparse and dense embeddings generated for the intent, intent category, and telemetry data. In embodiments where there is no telemetry data corresponding to the intent, the dialogue system does not generate embeddings of the telemetry data. Closeness of embeddings can, for the doc2vec embeddings, be quantified by Euclidean distance of embeddings. For the one-hot encodings, closeness can be quantified by the Okapi BM25 ranking function. The dialogue system can have a threshold semantic and lexical similarity according to relevance scores corresponding to quantified lexical and semantic similarity and can query the first and second databases for documents with lexical and/or semantic similarity to the intent, the intent category, and/or the telemetry data below respective thresholds. Logic can vary by implementation—the dialogue system can require similarity for all or a subset of the intent, the intent category, and the telemetry data be below respective thresholds. If the dialogue system retrieves any matching documents, operational flow proceeds to block 302. Otherwise, if the dialogue system retrieves documents but none are matching or if the dialogue system retrieves no documents, operational flow skips to block 304.

At block 302, the dialogue system generates an overall ranking of retrieved documents based on fusing semantic rankings and lexical rankings according to their respective scores. Each score of closeness/similarity can be tuned based on desired balance between lexical and semantic similarity. Tuning can occur as a training operation by observing quality of document matches to intents for preconstructed intents. The overall ranking can then be determined by adding the tuned scores for lexical similarity and semantic similarity with higher scoring documents having higher rankings.

At block 304, the dialogue system determines whether there are one or more matching documents and/or whether is telemetry data present for any security appliance(s). In some instances, certain security appliances such as those deployed in isolation on a private network can have telemetry data disabled. If there is matching documents and no telemetry data for a security appliance(s), operational flow proceeds to block 306. If there is telemetry data for a security appliance(s) and no matching document(s) or if there is telemetry data for a security appliance(s) and there are matching document(s), operational flow proceeds to block 312. Otherwise, if there is no telemetry data for a security appliance(s) and no matching document(s), operational flow skips to block 318.

At block 306, the dialogue system generates abstractive summaries of the high ranked document(s). The dialogue system can choose the top-n (e.g., top-3 or top-5) highest scoring documents as the high ranked documents, can choose the top scoring document as the highest ranked document, can impose a threshold combined lexical/semantic similarity score for a document to be highest rank, etc.

At block 308, the dialogue system generates one or more prompts for a language model with the intent, intent category, user telemetry data, abstractive summaries, and indications of tone and verbosity. The one or more prompts can additionally comprise indications of hyperlinks (e.g., URLs) to access documents whose abstractive summaries are included. The language model can comprise a LLM trained on general language tasks and fine-tuned to data specific to the cybersecurity organization. For instance, the dialogue system can generate training data comprising prompts that include intents, intent categories, user telemetry data, and abstractive summaries for utterances and corresponding desired responses. The dialogue system can then fine-tune the LLM by allowing parameters of a few final internal layers to vary during training via backpropagation using the training data.

At block 310, the dialogue system generates a response with the one or more prompts and the language model, for instance by prompting the language model with the one or more prompts and obtaining the response from the language model in response to the one or more prompts. Although an LLM is provided as an example for response generation, the dialogue system can implement any model that generates responses to the user utterance based on the inputs. For instance, the language model can alternatively comprise a schema that maps relevant entities and metadata in the intent, intent category, user telemetry, and abstractive summaries to fields in a previously generated template, and the dialogue system can comprise a component that maps intents to templates for the responses. The operational flow in FIG. 3 terminates.

At block 312, the dialogue system matches at least one of the intent, the intent category, and the user telemetry data with playbook agents. The user telemetry data can comprise a configuration of corresponding security appliances which can inform which playbook agent to deploy. Playbook agents can be indexed in a database or other data structure for retrieval based on security appliance type, version, enabled service(s), security policy configuration, as well as NLP embeddings of various intents. In some instances, the dialogue system can match with multiple playbook agents and indicate each playbook agent in a response to the user. If there is at least one matching playbook agent, operational flow proceeds to block 316. Otherwise, operational flow proceeds to block 318.

At block 316, the dialogue system generates a response(s) from the matching playbook agent(s). For instance, for multiple playbook agents the dialogue system can generate a separate response for each playbook agent and can indicate to the user that the security appliance issue related to the intent may be resolved by any of the responses/playbook agents. Each playbook agent acts as a dialogue system with the user, requesting various data related to the utterance as input that informs how the playbook agent resolves the problem. For instance, a playbook agent for upgrading a version of a security appliance can request a type/version of the security appliance, parameters of the security policy configuration of the security appliance, a security zone where the security appliance is deployed, etc. In some embodiments the playbook agent can receive this input data directly from the intent, intent category, and user telemetry data and can generate a recommendation to the user without additional input. The operational flow in FIG. 3 terminates.

At block 318, the dialogue system generates a response prompting the user to create a ticket. For instance, the response can include a hyperlink to a portal for ticket creation. The dialogue system can populate fields of the ticket creation portal with metadata such as the associated security appliance, metadata of the security appliance, etc.

### Variations

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted at block 216 can be performed in parallel or concurrently across security appliances. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

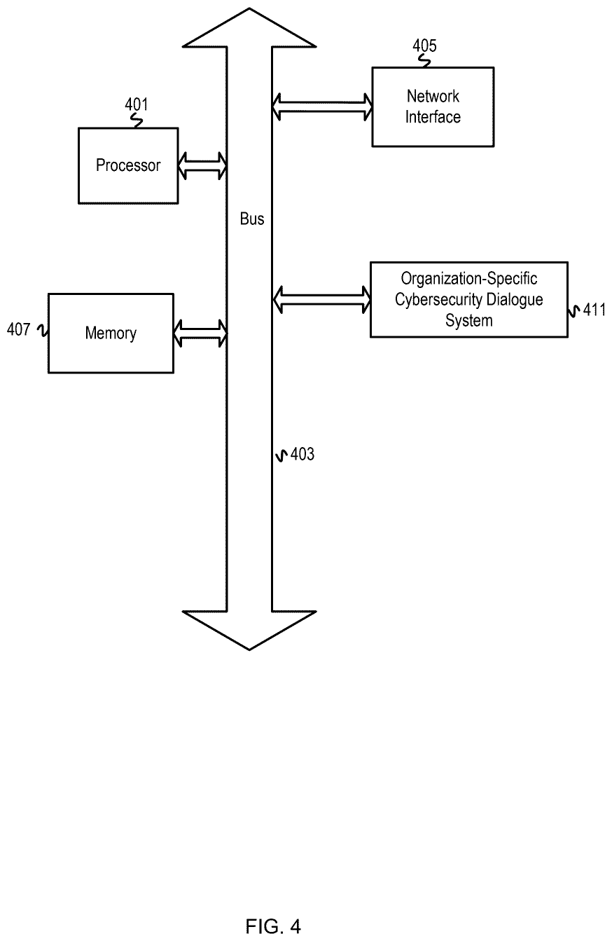

FIG. 4 depicts an example computer system with an organization-specific cybersecurity dialogue system. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes an organization-specific cybersecurity dialogue system (“dialogue system”) 411. The dialogue system 411 determines intent and intent category from a user utterance related to cybersecurity. The dialogue system 411 then extracts any relevant entities from the intent, retrieves user telemetry data related to the intent, and matches the user telemetry data, intent, and intent category to documents of the organization. If the user telemetry data indicates security appliances for the user or a tenant associated with the user, the dialogue system 411 matches the intent, intent category, and user telemetry data with playbook agents and invokes the matching playbook agents to generate a response(s) to the user. If the user telemetry data does indicate any security appliances, the dialogue system 411 generates a response with an LLM using the intent, intent category, user telemetry data, and abstractive summarizations of matching documents. If there are no matching documents/playbook agents, the dialogue system 411 prompts the user to create a ticket detailing the cybersecurity issue. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

1. A method comprising:
based on a first utterance of a user, obtaining from a first language model a first intent and an intent category of the first intent;
identifying one or more first entities and first metadata for the user based, at least in part, on the first intent and the intent category;
matching at least one of the one or more first entities, the first metadata, the first intent, and the intent category with documents for an organization to obtain one or more documents, wherein the matching is according to at least one of semantic similarity and lexical similarity;
ranking the one or more documents for relevance to the first utterance based on a combination of semantic similarity and lexical similarity; and
generating a response to the first utterance that at least indicates a subset of highest ranked documents of the one or more documents.

2. The method of claim 1 further comprising, based on determining that the first metadata for the organization do not indicate one or more security appliances,
identifying a playbook agent that matches at least one of the one or more first entities, the first metadata, the first intent, and the intent category; and
generating a response to the first utterance based on inputting features of at least one of the one or more first entities, the first metadata, the first intent, and the intent category into the playbook agent.

3. The method of claim 1, further comprising, based on determining at least one of that one or more second entities, second metadata, a second intent, and a second intent category for a second utterance do not match a playbook agent and do not match the documents for the organization and that the one or more second entities, the second metadata, the second intent, and the second intent category do not match the documents for the organization and the second metadata do not indicate one or more security appliances, generating a response to the first utterance prompting the user to create a ticket related to the first utterance.

4. The method of claim 1, wherein the organization comprises a cybersecurity organization, wherein the first utterance is related to operations of a cybersecurity implementation for the user by the organization.

5. The method of claim 1, wherein ranking the one or more documents based on semantic similarity and lexical similarity comprises,
ranking the one or more documents based on semantic similarity with at least one of the one or more first entities, the first metadata, the first intent, and the intent category to obtain a first ranking;
ranking the one or more documents based on lexical similarity with at least one of the one or more first entities, the first metadata, the first intent, and the intent category to obtain a second ranking; and
fusing the first ranking and the second ranking to obtain a third ranking as the ranking of the one or more documents based on a combination of semantic similarity and lexical similarity.

6. The method of claim 1, wherein generating the response comprises abstractive summary generation of content from the subset of highest ranked documents of the one or more documents to generate one or more summaries of the subset of highest ranked documents.

7. The method of claim 6, wherein generating the response further comprises,
generating one or more prompts to a second language model, wherein the one or more prompts comprise the one or more summaries and indications of tone and verbosity for the response; and
prompting the second language model with the one or more prompts to obtain the response.

8. The method of claim 1, wherein the first language model comprises a large language model, wherein inputting the first utterance into the large language model comprises few-shot prompting one or more prompts as inputs to the large language model to obtain the first intent and the intent category as output.

9. A non-transitory machine-readable medium having program code stored thereon, the program code comprising instructions to:
invoke a first language model on a first utterance by a user to determine a first intent and a first intent category of the first intent;
identify one or more first entities and first metadata for the user based, at least in part, on matching the first intent with telemetry data for the user;
retrieve one or more documents of an organization matching at least one of the first intent, the first intent category, the one or more first entities, and the first metadata, wherein each of the one or more documents is similar to at least one of the first intent, the first intent category, the one or more first entities, and the first metadata according to at least one of semantic similarity and lexical similarity;
rank the one or more documents for relevance to the first utterance based on a combination of semantic similarity and lexical similarity; and
generate a response to the first utterance that at least one of indicates and summarizes a subset of highest ranked documents of the one or more documents.

10. The non-transitory machine-readable medium of claim 9 wherein the program code further comprises instructions to, based on determining that the first metadata for the organization do not indicate one or more security appliances,
identify a playbook agent that matches at least one of the one or more first entities, the first metadata, the first intent, and the first intent category; and
generate a response to the first utterance based on inputting features of at least one of the one or more first entities, the first metadata, the first intent, and the first intent category into the playbook agent.

11. The non-transitory machine-readable medium of claim 9, wherein the program code further comprises instructions to, based on determining at least one of that one or more second entities, second metadata, a second intent, and a second intent category for a second utterance do not match a playbook agent and do not match documents for the organization and that the one or more second entities, the second metadata, the second intent, and the second intent category do not match documents for the organization and the second metadata do not indicate one or more security appliances, generate a response to the second utterance prompting the user to create a ticket related to the second utterance.

12. The non-transitory machine-readable medium of claim 9, wherein the organization comprises a cybersecurity organization, wherein the first utterance is related to operations of a cybersecurity implementation for the user by the organization.

13. The non-transitory machine-readable medium of claim 9, wherein the program code to rank the one or more documents based on semantic similarity and lexical similarity comprises instructions to,
rank the one or more documents based on semantic similarity with at least one of the one or more first entities, the first metadata, the first intent, and the first intent category to obtain a first ranking;
rank the one or more documents based on lexical similarity with at least one of the one or more first entities, the first metadata, the first intent, and the first intent category to obtain a second ranking; and
fuse the first ranking and the second ranking to obtain a third ranking as the ranking of the one or more documents based on the combination of semantic similarity and lexical similarity.

14. The non-transitory machine-readable of claim 9, wherein the first language model comprises a large language model, wherein the instructions to input the first utterance into the large language model comprise instructions to few-shot prompt one or more prompts as inputs to the large language model to obtain the first intent and the first intent category as output.

15. An apparatus comprising:
a processor; and
a machine-readable medium having instructions stored thereon that are executable by the processor to cause the apparatus to,
invoke a first language model on a first utterance by a user to determine a first intent and a first intent category of the first intent;
identify one or more first entities and first metadata for the user based, at least in part, on matching the first intent with telemetry data for the user;
retrieve one or more documents of an organization matching at least one of the first intent, the first intent category, the one or more first entities, and the first metadata, wherein each of the one or more documents is similar to at least one of the first intent, the first intent category, the one or more first entities, and the first metadata according to at least one of semantic similarity and lexical similarity;
rank the one or more documents for relevance to the first utterance based on a combination of semantic similarity and lexical similarity; and
generate a response to the first utterance that at least one of indicates and summarizes a subset of highest ranked documents of the one or more documents.

16. The apparatus of claim 15, wherein the machine-readable medium further has stored thereon instructions executable by the processor to cause the apparatus to, based on determining that the first metadata for the organization do not indicate one or more security appliances,
identify a playbook agent that matches at least one of the one or more first entities, the first metadata, the first intent, and the first intent category; and
generate a response to the first utterance based on inputting features of at least one of the one or more first entities, the first metadata, the first intent, and the first intent category into the playbook agent.

17. The apparatus of claim 15, wherein the machine-readable medium further has stored thereon instructions executable by the processor to cause the apparatus to, based on determining at least one of that one or more second entities, second metadata, a second intent, and a second intent category for a second utterance do not match a playbook agent and do not match documents for the organization and that the one or more second entities, the second metadata, the second intent, and the second intent category do not match documents for the organization and the second metadata do not indicate one or more security appliances, generate a response to the second utterance prompting the user to create a ticket related to the second utterance.

18. The apparatus of claim 15, wherein the organization comprises a cybersecurity organization, wherein the first utterance is related to operations of a cybersecurity implementation for the user by the organization.

19. The apparatus of claim 15, wherein the instructions to rank the one or more documents based on semantic similarity and lexical similarity comprise instructions executable by the processor to cause the apparatus to,
rank the one or more documents based on semantic similarity with at least one of the one or more first entities, the first metadata, the first intent, and the first intent category to obtain a first ranking;
rank the one or more documents based on lexical similarity with at least one of the one or more first entities, the first metadata, the first intent, and the first intent category to obtain a second ranking; and
fuse the first ranking and the second ranking to obtain a third ranking as the ranking of the one or more documents based on the combination of semantic similarity and lexical similarity.

20. The apparatus of claim 15, wherein the first language model comprises a large language model, wherein the instructions to input the first utterance into the large language model comprise instructions executable by the processor to cause the apparatus to few-shot prompt one or more prompts as inputs to the large language model to obtain the first intent and the first intent category as output.
